(19) United States
(12) Patent Application Publication
(10) Pub. No.: US 2007/0104551 A1
(43) Pub. Date: May 10, 2007

(54) Tool for trimming boreholes

(75) Inventor: Gilbert Gaiser, Sigmaringen (DE)

Correspondence Address: BURR & BROWN, PO BOX 7068, SYRACUSE, NY, 13261-7068, US

(73) Assignee: Joerg GUEHRING, Albstadt (DE)

(21) Appl. No.: 11/516,019

(22) Filed: Sep. 5, 2006

Related U.S. Application Data
(63) Continuation of application No. PCT/EP05/02200, filed on Mar. 2, 2005.

(30) Foreign Application Priority Data
Mar. 3, 2004 (DE) 10 2004 010 372.0

(51) Int. Cl. B23C 3/00

(52) U.S. Cl. 409/132; 409/136; 409/143; 409/138; 409/140; 408/1 R

(57) ABSTRACT

The invention relates to a tool for trimming lines of intersection on the ends of boreholes. Said tool has a cutting head which is arranged on a shaft and at least one cutting edge that extends in the axial direction, at least in sections, and carries out a machining process by a relative rotational movement between the tool and the workpiece. The inventive tool is provided with a device for generating a radial force, by which means the cutting head can be radially deflected in the rotational movement thereof in a preferably controlled manner, said cutting head having a diameter (DS) that is selected in such a way that it can be introduced into the borehole with radial play (SR). The cutting head is essentially in the form of a droplet and has a smooth closed surface in the region of the largest outer diameter thereof.

The invention relates to a tool for trimming boreholes which, for example, end laterally in a cylindrical recess, according to the precharacterising part of claim 1, as well as to a method for trimming such boreholes according to claim 37.

Such a generic tool is known from the European patent application EP 1 362 659 A1 (application number 03011272.6-1262), published on 19.11.2003, to which the present application expressly refers, and whose content is expressly incorporated into the present application.

It has been shown that a tool of the type shown, for example, in FIGS. 20 to 22 of the European patent application EP 1 362 659 A1 is reliably able to neatly and gently remove the burr or residual chip which remains after metal-cutting processing at the point where a borehole leads to a recess, in that the cutting head that rotates in relation to the borehole, said cutting head having been inserted into the borehole so that it comes to rest radially within the location to be trimmed, by means of the device for generating a radial force is made to carry out an “orbital” i.e. a “wobbling” scraping movement or cutting movement along the outlet orifice.

In this arrangement the cutting edge of the cutting head, of which cutting edge there is at least one, is on a cycloid in relation to the internal surface of the borehole, which reliably prevents the occurrence of residual chip formation at some other position in the borehole.

However, the known tool can only be used optimally if the line of intersection of the outlet point between the borehole and the recess has a relatively short axial extension, which as a rule is the case when the axis of the borehole is essentially perpendicular on the internal surface of the recess, or—if the recess is also a cylindrical recess—when the diameter of the borehole is small in relation to the internal diameter of the recess, and when the axes of the borehole and the recess intersect at a right angle. This is the only way, during application of simple movement kinematics of the cutting head, to effectively preclude the cutting head—in a situation where the cutting edge, of which there is at least one, of said cutting head processes that position of the line of intersection which is closest to the chuck location of the tool—from leaving the inner borehole undamaged in the remaining region.

It is thus the object of the invention to improve the generic tool and the trimming method applied with said tool such that, while maintaining simple movement control of the tool, any desired lines of intersection between the borehole and the recess can be effectively trimmed without damaging or excessively scratching the internal surface of the borehole.

In relation to the tool, this object is met by the characteristics of claim 1, while in relation to the method, said object is met by claim 37.

The geometric design, according to the invention, of the cutting head, whose club shape or droplet shape has been modified such that said cutting head in the region of its largest outer diameter has a smooth closed surface, ensures that the cutting head, even if during its wobble-scrape movement carries out axial movement that is not specially coordinated with the line of intersection, in order to cover the entire line of intersection cannot damage the internal surface of the borehole, even if said cutting head processes the position of the line of intersection, which position is located closest to the chuck location of the tool. The cutting edge, of which there is at least one, can engage the line of intersection only where the smooth closed surface can project from the borehole. The tool according to the invention is thus particularly well suited to the processing of lines of intersection of outlet boreholes, where the axis of the boreholes is arranged at an acute angle, preferably at a very acute angle in relation to the internal surface or to the axis of the recess.

This results in an additional advantage in that the trimming process can be carried out more economically with the use of the tool according to the invention. The time required for trimming can be reduced because it is no longer necessary to switch off the rotary drive for the tool when the trimming process is completed before the tool is inserted into the next borehole. Due to the smooth closed surface in the region of the largest diameter of the cutting head, said cutting head cannot damage the borehole edge even if the tool is positioned comparatively inaccurately in relation to the borehole axis.

The tool according to the invention can be used both for trimming internal lines of intersection and for trimming external lines of intersection.

Advantageous improvements are the subject of the subordinate claims.

The radial force acting on the cutting head to achieve said cutting head's preferably controlled radial excursion can be generated in various ways.

Advantageous variants are the subject of the subordinate claims 2 to 7 and 8 to 10.

A particularly simple construction is achieved with the improvements according to subordinate claims 2 to 7. In these claims, a pressurised flow agent, which is present anyway in standard machining centres, for example a coolant and lubricant used in metal-cutting processing, is used for radially deflecting the cutting head so that it carries out the trimming function.

In this deflection it is not only the pulse forces caused by the dynamic pressure of the flow agent in the region of the branch duct, but also the pulse forces caused by the deflection of the flow-agent flow that play a role so that the effective radial force remains well controllable.

By way of the pressure of the flow agent and/or the geometry of the tool shaft, radial deflection of the tool shaft and thus of the cutting head can be controlled within wide margins so that the radial play of the cutting head in the recess can also be specified comparatively inaccurately. As a consequence of this, the tool becomes more economical. Similarly, the control of the drive device in which the tool is held can be greatly simplified as a result of this because the tool can be positioned comparatively inaccurately in relation to the axis of the recess. The tool can thus be clamped in machines that work with relatively little precision. The tool is self-positioning as a result of its scraping movement on the internal circumference of the recess. It has been found that the operating principle according to the invention is applicable in relation to the entire spectrum of commonly used materials, i.e. steel, grey cast, right across to plastics.

Basically a single branch duct is sufficient in order to build up a pressure force in the region between the outlet orifice of said duct and the internal wall of the recess, which pressure force adequately deflects the tool in radial direction for at least one cutting edge to be effectively engaged.

A particularly effective manner of machining results if several branch ducts are provided. This modification further makes it possible to affix several cutting edges to the cutting head so that the required machining time can be further reduced. It is also possible for the branch ducts to be staggered in axial direction.

Experiments have shown that particularly advantageous results can be achieved with dimensions of the branch duct according to claim 3.

By way of the length of the shaft the radial flexibility of the tool can easily be controlled, wherein there is an advantageous side effect in that a long shaft results in the tool being able to be used more universally, i.e. for trimming boreholes that end relatively deep in the interior of the recess.

The field of application preferably covers shaft lengths ranging from 5 to 1,000 mm.

In principle the branch duct can be aligned as desired; it can also be curved, for example helical in shape. Preferably, the branch duct, of which there is at least one, is straight, wherein it can be a borehole or an eroded recess. The latter case allows more flexibility in the design of the cross section of the duct.

If the cutting edge, of which there is at least one, is set at an angle to the axial plane of the tool, cutting conditions during trimming can be influenced in a targeted way so that working accuracy is enhanced.

Good results can be achieved with radial play according to claim 17, wherein this play is coupled to the extent of working pressure of the flow agent.

A very simple alternative design of the device for generating a radial force forms part of claims 8 to 10. In those claims an unbalanced mass of the tool is used for controlled radial deflection of the cutting head. By way of the rotary speed, the absolute extent of radial deflection can be controlled in a simple manner, which makes it possible to insert the cutting head into the recess or borehole, for example, at a relatively low rotary speed, and subsequently to sufficiently increase the rotary speed so that the desired trimming movement of the tool's cutter, of which cutter there is at least one, is generated. In this embodiment the design of the cutter head or of the cutters can be identical to that of the previously described variant.

A further option of influencing radial deflection consists of optimising the geometry of the tool shaft. With the improvement according to claim 13 the required radial flexibility of the shaft can be further improved.

With the improvement of claim 15 insertion of the tool is further simplified. The tool can in principle also be used to trim the entry opening of a borehole on the outside of a body or of a cylinder, wherein in this case the tool is either inserted into the borehole from the inside towards the outside, or the cutting head comprises a cutting edge on both sides of the smooth closed surface. A variant tailored to trimming of lines of intersection located on the inside is the subject of claim 15. In this arrangement the cutting edge on the undercut side of the cutting head approaches the inside outlet opening of the borehole from the inside. In this process the wobble movement of the cutting head gradually scrapes regions of the borehole burr if it is not aligned in a plane that is perpendicular to the borehole axis, while the remaining regions of the inner wall of the borehole, which regions are axially offset in relation to the trimming position, are exposed to the smooth closed surface which, however, has no influence on the inner surface of the borehole.

There are practically no limitations relating to the selection of materials for the tool. Advantageous materials relating to the cutting head are stated in claim 18, and relating to the shaft in claim 23, wherein suitable coatings can, in particular, also be used in the embodiment according to claims 24 to 36.

According to claim 6 there is a particular advantage in that in the tool the interface to the flow-agent connection is established with simple means.

With the improvement according to claim 7 the tool becomes an easily handled unit that can be inserted into commonly used tool-holding fixtures. In this arrangement the attachment- and fastening body at the same time forms the body for feeding-in the flow agent. This body is preferably in the shape of an elongated hollow cylinder which can even be glued to the shaft of the tool. When it comprises a suitable corrosion-resistant coating, this body can be made from ordinary steel because fixing to the tool-holding fixture can take place in that, by means of the flow-agent pressure that acts on the rear, the cylindrical body is pressed against a shoulder area in the tool-holding fixture.

When the effective cutting angle, or in the embodiment involving a milling cutter or a reamer, the tool back rake, is kept positive, for example ranging from 0 to 10°, preferably to 5°, the cutting edge can apply its metal-cutting effect already at relatively light radial pressure forces so that the flow-agent pressure can be kept lower.

The embodiment according to claim 21 results in a somewhat scraping effect of the cutting edge, of which there is at least one. The profile of the cutting edges is similar to that of a file, so that machining should be carried out with a higher flow-agent pressure when compared to the embodiment according to claim 20.

If the cutting edge, of which there is at least one, is essentially helical in shape, this results in a particularly favourable cutter design for removing the burr.

Improving the tool according to claim 23 has advantages in particular if the shaft of the tool is extremely thin, for example in cases where the trimming procedure is to be carried out in the region of a borehole with a diameter of less than 1 mm that follows on from a comparatively deep borehole that is also of small diameter, for example up to approximately 4 mm. The material selection ensures that even with such a thin shaft design the tool remains sufficiently stable to precisely centre the cutting head even after repeated use. In this way the machining accuracy can be particularly well controlled. The cutting head itself can then be made from other materials and can, for example, be detachably affixed to the shaft of the tool.

It has been shown that the flow agent itself can be made of a gaseous medium, such as for example air, in order to generate the forces necessary to deflect the tool shaft. Of course any commonly applied coolants and lubricants can be used, including those used in reduced quantity lubrication techniques.

Preferably the device is operated at a flow-agent pressure ranging from 3 to 3,000 bar.

If the tool comprises an attachment- and fastening body according to claim 7, it is advantageous if said fastening body is accommodated in the tool-holding fixture in the manner of a bayonet joint. A particular aspect of the present invention consists of the comparatively high flow-agent pressure to be used to fix the tool in the tool-holding fixture both axially and in circumferential direction. It has been shown that the cutting forces during trimming can easily be absorbed by the frictional force that arises when the attachment- and fastening body is pushed against a holding shoulder by the pressure of the flow agent. This is still further facilitated in that the diameter of the attachment- and fastening body can exceed the diameter of the cutting head. Such a design is described in the European patent application EP 1 362 659 A1.

The essential elements of the method, according to the invention, for trimming boreholes, for example boreholes that end laterally in an essentially cylindrical recess, are the subject of claim 37.

The method of claim 38 is associated with a particular advantage in series machining of boreholes, where a multitude of boreholes have to be reliably trimmed in the shortest possible time. According to the invention the rotary drive of the tool does not have to be switched off after leaving a borehole and before the tool enters the next borehole.

Further advantageous embodiments form part of the remaining subordinate claims.

Below, several exemplary embodiments of the invention are explained in more detail with reference to diagrammatic drawings. The following are shown:

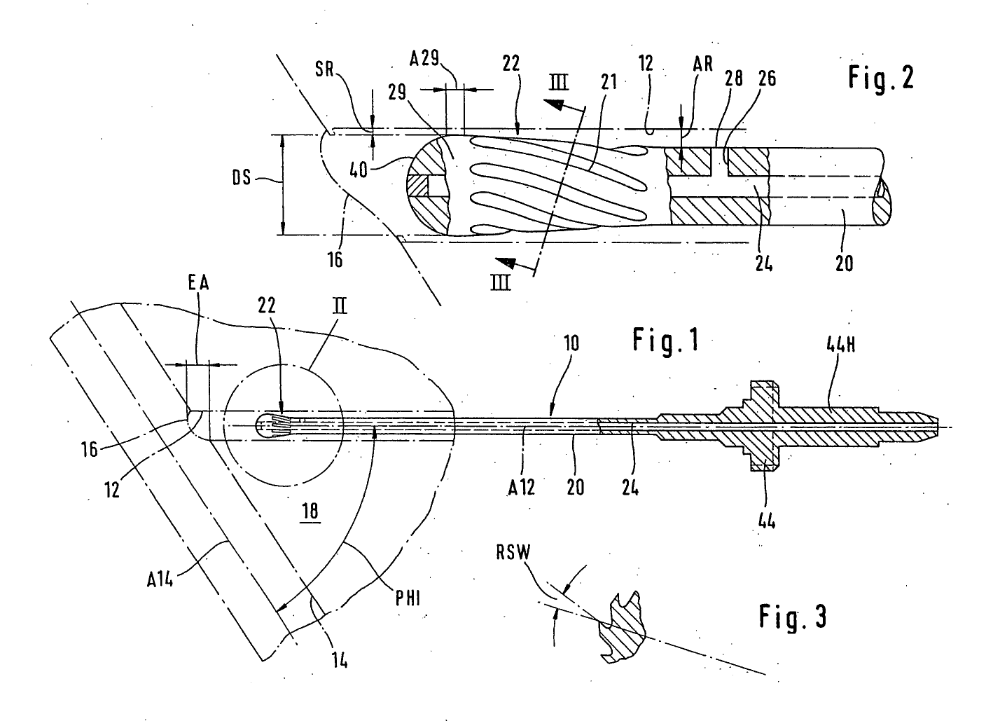

FIG. 1 shows a lateral view of a tool for trimming boreholes that end laterally in, for example, a cylindrical recess;

FIG. 2 shows the detail II from FIG. 1;

FIG. 3 shows the partial section III-III from FIG. 2;

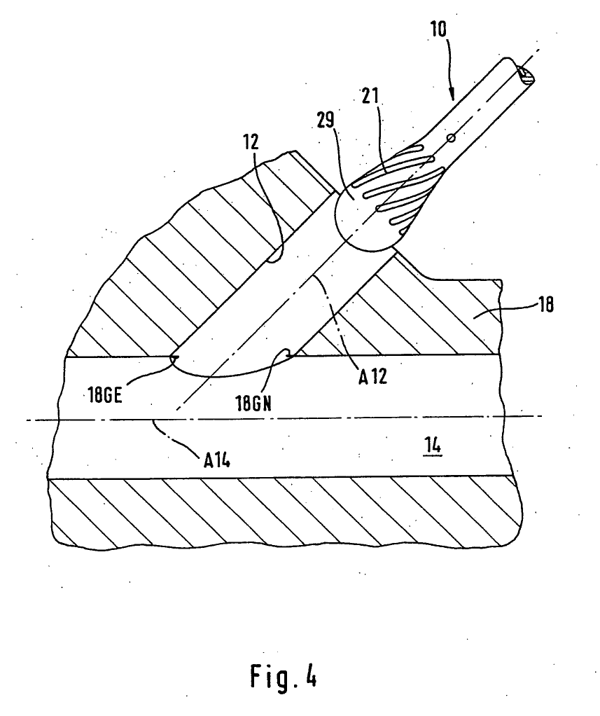

FIGS. 4 to 6 are large-scale views of the tool according to FIGS. 1 to 3 in various operational phases of the machining process;

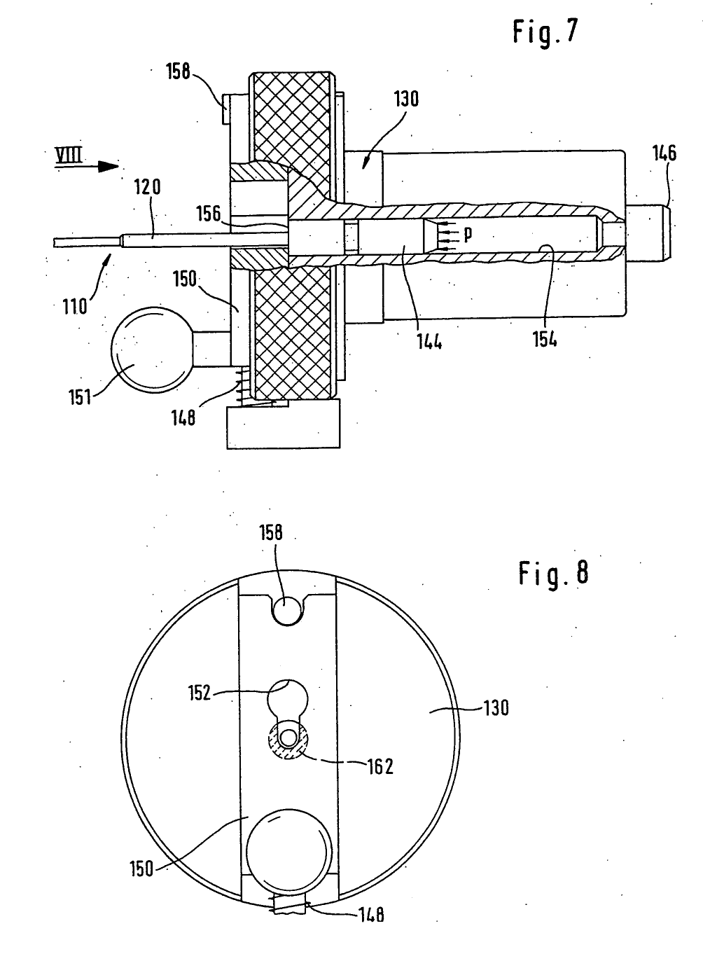

FIG. 7 shows a diagrammatic partial view of a variant of the tool according to FIGS. 1 to 3 with the accommodation and fixture in a tool-holding fixture being indicated;

FIG. 8 shows the view “VIII” of FIG. 7;

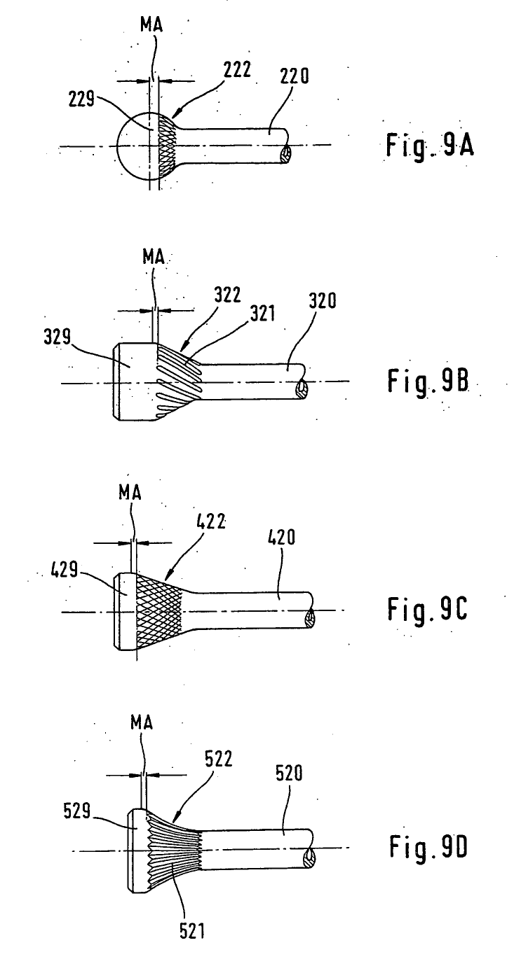

FIGS. 9A to 9D show diagrammatic views of modified cutting heads of the tool;

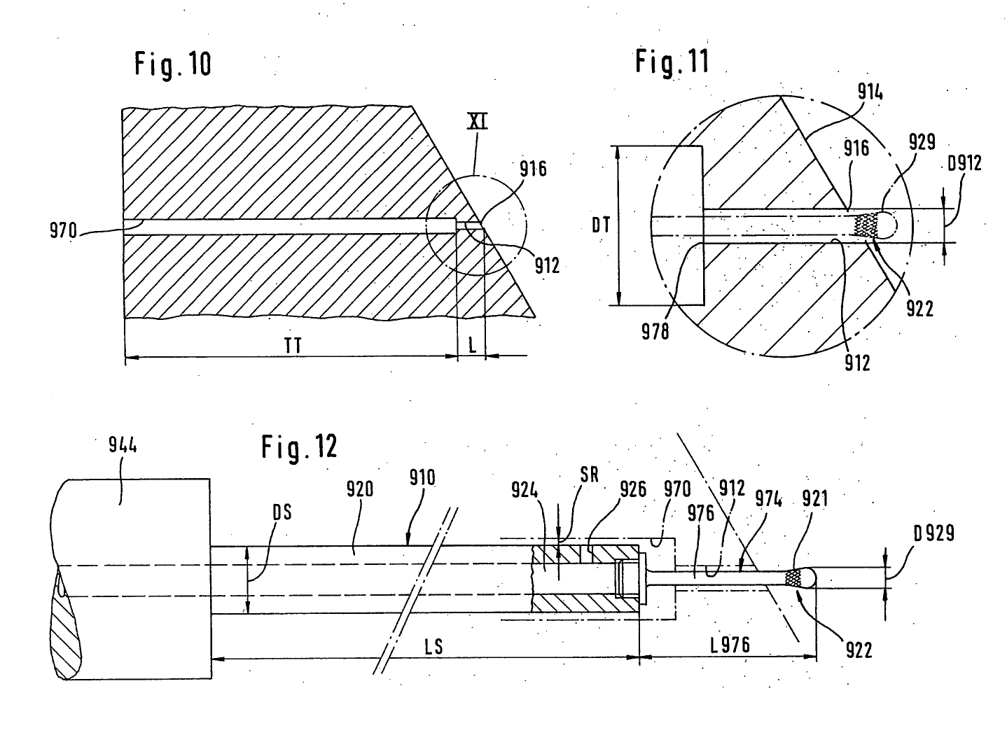

FIG. 10 shows a diagrammatic view of a borehole that is to be trimmed in particularly inaccessible locations by means of a specially designed tool according to the invention;

FIG. 11 shows the detail “XI” from FIG. 10; and

FIG. 12, at a somewhat reduced scale when compared to that of FIG. 11, shows a tool with which the machining task according to FIGS. 10 and 11 can be carried out.

In FIG. 1 the reference character 10 shows a preferably rotationally symmetric finishing tool that is, for example, rotary driven, in an embodiment as a trimming tool, with which it is possible, in a particularly economical way and particularly reliably, to trim the radial inner ends, i.e. the region of the line of intersection 16, of boreholes 12 which at an acute angle PHI end laterally in an essentially cylindrical recess 14 in a workpiece 18. However, it should be pointed out that the tool can also be static, and instead, or in addition, the workpiece can be made to rotate. Furthermore, the tool can also be used for trimming outlet orifices on the, for example, external cylindrical surface of the workpiece.

The tool comprises a cutting head 22 on a shaft 20, which cutting head has at least one cutting edge 21—in the example shown it has a plurality of helical cutting edges that are evenly distributed around the circumference—which cutting edges 21 can carry out metal-cutting processing. Preferably, the cutting head comprises a plurality of cutting edges 21, which at least in sections extend in axial direction, as shown in FIG. 2.

The tool comprises an interior flow-agent duct 24, from which in the region of the shaft 20 at least one branch duct 26 emanates. This branch duct 26 is arranged such that with its outlet orifice 28 it comes to rest at a predefined radial spacing AR (shown enlarged in FIG. 2) in relation to the internal surface of the borehole 12 when the cutting head 22 of the tool has been inserted into the borehole 12 until the cutting edges 21 in the region of the cutting head 22 completely overlap the line of intersection 16, as shown in FIG. 5.

As shown in FIGS. 2 and 3 the cutting edges 21 are distributed around the entire circumference so that the outlet orifice 28 is at circumferential spacing to at least one cutting edge 21, for example to the diametrically opposed cutting edge.

FIGS. 1 to 3 further show that the diameter DS of the cutting head 22 has been selected such that it can be inserted with radial play SR into the borehole 12. The radial play is preferably up to several tenths of millimetres, e.g. ranging from 0.1 mm to 5 mm.

A special feature of the tool consists of the tool being tailored specifically for trimming lines of intersection 16 that have a relatively long axial length EA (FIG. 1), which is for example the case when the axis A14 of the borehole 14 is arranged at an acute angle PHI in relation to the axis A12 of the borehole 12.

The cutting head 22 conically widens, starting from the shaft 20, up to a region 29 of the largest diameter, which region follows on from the region of the cutting edges 21. The region of largest diameter 29 has a smooth closed surface. The axial length is variable; in FIG. 3 it is designated A29.

A round tip section 40 follows on from the region 29, which tip section 40 is also smooth, i.e. without any cutting edges or without other machining profiles.

The cutting head 22 is thus essentially in the form of a droplet.

The tool according to FIGS. 1 to 3 thus has a cutting edge design such that a positive effective cutting angle or tool back rake RSW is formed on the cutting edge 21. In this way a cutting function is imparted to the cutting edge 21. However, it is also possible to design the angle RSW so that it is negative.

Axial and rotatory fastening of the tool in a tool-holding fixture takes place in the manner of a bayonet joint. On its end facing away from the cutting head 22, the shaft 22 comprises an attachment- and fastening body 44 by means of which the tool can be fastened so as to be torsionally rigid and non-slidable. This body is essentially rectangular in shape and interacts with an undercut recess (not shown in detail) in the tool-holding fixture, which recess is designed in the manner of a bayonet joint.

With this design of the tool the following working principle with the effects described below with reference to FIGS. 4 to 6 can be implemented.

In order to implement the rotary drive the tool 10 is accommodated in a tool-holding fixture so as to be torsionally rigid and non-slidable. The tool-holding fixture is associated with a rotary drive (not shown in detail), a feed drive and a flow-agent pressure source.

However, the feed and/or,the rotary drive can also be provided for the workpiece 18. Furthermore, an additional rotary drive and/or feed device can be provided for the workpiece 18.

When the borehole 12 in the radial inner outlet region is to be trimmed, the tool 10 is first moved to the borehole 12 (position according to FIG. 4). Due to the radial play SR positioning can be relatively inaccurate, which makes it possible to use relatively inaccurate machines. Furthermore, because the region 29 of the cutting head, i.e. the region of largest diameter, comprises a smooth closed surface, the cutting edges 21 can damage neither the outlet 17 nor the internal surface of the borehole 12, even if the tool is inserted into the borehole 12 with the rotary drive running.

The tool 10 is then inserted sufficiently far into the borehole 12 (or a corresponding kinematically inverse movement ensures a corresponding relative position) for the outlet position, i.e. the line of intersection 16 with the diagrammatically indicated residual chip or burr 18G, to be reached. This position is shown in FIG. 5.

At the latest when the front-most cutting edge 21 has reached this position, flow agent, for example water or some other tool coolant and lubricant, or a gaseous flow agent, is fed to the internal flow-agent duct 24 at relatively high pressure of between 3 and 3,000 bar. Thus, interaction with the interior circumferential wall of the borehole 14 results in corresponding dynamic pressure in the region of the outlet orifice 28, of which there is at least one. In addition, due to the pulse resulting from the deflection of flow agent, a radial excursion force acts on the cutting head 22, which is subjected to eccentric orbital movement. The cutting edges thus move on a cycloid.

If several outlet orifices 28 are provided, they are unevenly distributed on the circumference, such that the sum of the dynamic pressure forces generated in the region of the outlet orifices 28 between the cutting head 22 and the interior wall of the borehole can deflect the shaft 20 in radial direction so that the cutting edge that is situated opposite the resulting dynamic pressure force contacts the burr 18G that is to be machined, wherein such contact occurs at the line of intersection 16, thus cutting or scraping along said line of intersection 16.

In other words, at this point in time the tool makes an orbital movement that is superimposed on the rotary movement, with the radius of the orbital movement resulting from the play of the cutting head as shown in FIG. 5.

The branch ducts 28, which can also be axially staggered, have, for example, a diameter i.e. an inside diameter ranging from 0.1 to 5 mm.

The above description clearly shows that with the pressures of the flow agent as stated, the dynamic pressure forces are sufficient to deflect the flexible shaft 20 to an adequate extent. By means of the length of the shaft, which length can range from 5 to 1,000 mm, the elastic deformation can be controlled.

FIG. 2 shows that the branch ducts 26 are of a straight-line design. These ducts can be formed by a borehole or by an eroded recess.

FIG. 5 shows that the tool first removes the burr 18G that is furthest away from the tool-holding fixture (not shown). The burr 18GN is not necessarily reached by the cutting edges.

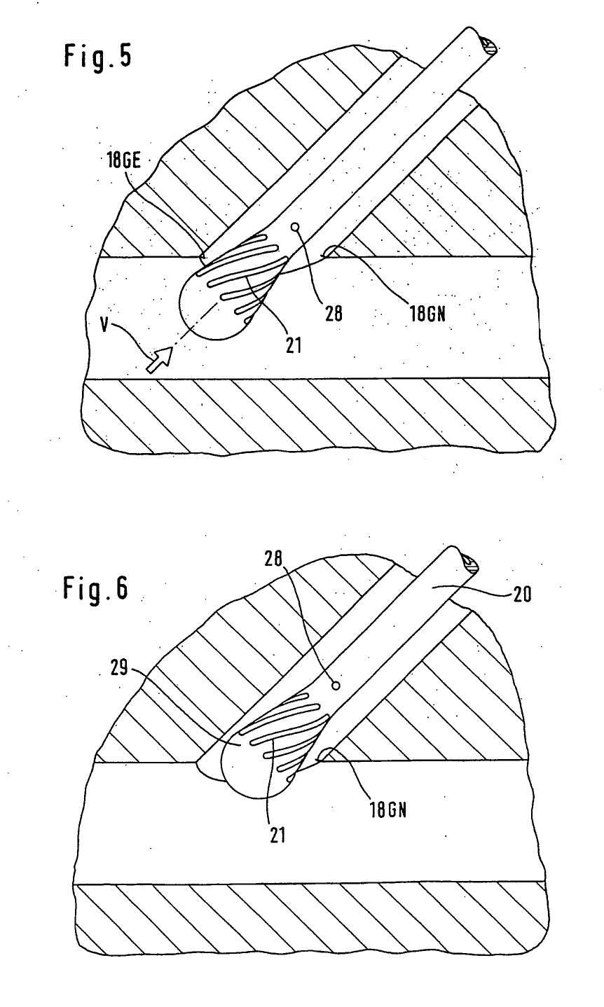

It is only when the tool is gradually withdrawn in axial direction V (compare FIG. 5) while the supply of flow agent is kept up that the cutting edges 21 come into close enough proximity to the burr 18GN so as to remove said burr 18GN. This phase is shown in FIG. 6. The diagram shows that in this phase the cutting edges 21 can contact the burr 18GN as a result of springy deflection of the shaft 20, but that contact between the cutting edges and the remaining internal surface of the borehole 12 is prevented because it is only the region 29 that contacts said internal surface. However, the region is smooth, i.e. it is not designed to have a metal-cutting or scraping effect, so that the quality of the internal surface remains undiminished.

The tool can be made from wear-resistant steel, high-speed steel (HSS, HSSE, HSSEBM), hard metal, ceramics or cermet and can comprise a suitable commonly applied coating.

Below, there is a description as to how the tool can be fastened to a tool-holding fixture so as to be torsionally rigid and non-slidable. To this effect reference is made to FIGS. 7 and 8, in which a variant of the tool according to FIG. 1 to 3 is indicated.

In FIG. 7 an attachment and fastening body, designated 44 in FIGS. 1 to 3, which attachment and fastening body is formed in one piece with the shaft 20, is designed as a glued-on cylindrical sleeve 144. Otherwise the tool 110 corresponds to the tool 10.

Those components in the embodiment according to FIG. 7, which components correspond to the components of the tool according to FIGS. 1 to 3, have corresponding reference characters that are prefixed by “1”.

The sleeve 144 is made of ordinary steel which preferably comprises a corrosion protection coating. In addition to gluing, a headless screw (not shown) can be used which connects the sleeve 144 to the shaft 120 in a positive-locking manner.

The designation 146 refers to a chamfer by means of which a fluid-proof connection to the flow-agent source is established.

The special feature of the embodiment according to FIGS. 7 and 8 consists of the flow-agent pressure being able to be used for holding the tool in a rotationally and axially secure manner in the tool-holding fixture 130.

To this effect a locking plate 150, which in the face of the tool-holding fixture 130 can be radially slid against a spring 148, is used, which locking plate 150 comprises a keyhole opening 152. When the locking plate 150 with activation button 151 is slid downwards against the force of the spring 148 in FIG. 8, the larger circular borehole in the locking plate is aligned with a cylindrical recess 154 in the tool-holding fixture 130 so that the tool can be inserted from the front into the tool-holding fixture. As soon as a shoulder 156 of the sleeve 144 moves behind the slide plane of the locking plate 150, the latter can slide upwards as a result of the action of the spring 148 until it abuts against a pin 158. In this process the slot-shaped section of the keyhole opening 152 slides along the outer circumference of the shaft 120. The sleeve 144 is thus, trapped behind the locking plate.

If accordingly, as indicated by the arrows in FIG. 7, the flow-agent pressure acts on the rear of the sleeve 144, the sleeve with the hatched area 162 is pressed against the rear of the locking plate. This compression force is adequate to provide rotational securing of the tool, all the more so since the cutting edges of the tool do not have to cut thick chips.

It has already been mentioned above that the flow-agent pressure should be increased to relatively high levels in order to ensure adequate radial deflection of the tool shaft. The pressure generation device should be in a position to generate flow-agent pressure ranging from 30 to 3,000 bar. For particular designs of the tool shaft and/or the clearance fit between the tool and the tool-holding fixture, pressures of 3 bar can, however, already be adequate.

Preferably the relative rotary speed between the tool and the workpiece is kept within the range of 100 and 50,000 rpm, wherein a cutting speed ranging from 20 to 300 m/min is selected.

Instead of using a flow-agent-activated device to generated a circumferential radial force, it is also possible to provide an unbalanced mass attached to the shaft. This unbalanced mass can be designed to be in one piece with the tool, or instead it can be designed to be a separate component on the tool, which component is preferably attached so that its position can be changed.

The shaft, too, can comprise a high-strength material, e.g. a hard material, a hard metal, a cermet material or a composite material, such as for example a carbon-fibre-reinforced plastic material, with the elasticity of the shaft being such that the radial deflections of the cutting head and thus of the shaft, which radial deflections occur during the trimming process, occur exclusively in the elastic deformation region.

At least in regions the tool comprises a coating, preferably in an embodiment as a hard material coating.

The hard material coating comprises, for example, diamond, preferably nanocrystalline diamond, made of TiN or (Ti, Al)N, a multilayer coating or a coating comprising nitrides with the metal components Cr, Ti and Al and preferably a small percentage of elements for grain refinement, wherein the Cr content is 30 to 65%, preferably 30 to 60%, particularly preferably 40 to 60%, the Al content is 15 to 35%, preferably 17 to 25%, and the Ti content is 16 to 40%, preferably 16 to 35%, particularly preferably 24 to 35%, in each case in relation to all metal atoms in the entire coating.

The structure of the entire coating can comprise a homogeneous mixed phase.

The structure of the entire coating has several individual layers that are homogeneous per se, which alternately comprise on the one hand (TiₓAl_{y}Y_{z})N, wherein x=0.38 to 0.5, and y=0.48 to 0.6, and z=0 to 0.04, and on the other hand CrN, wherein preferably the uppermost layer of the wear-resistant coating is formed by the CrN coating.

An alternative coating essentially comprises nitrides with the metal components Cr, Ti and Al and a small percentage of elements (κ) for grain refinement, with the following composition:
a Cr content exceeding 65%, preferably ranging from 66 to 70%;
an Al content of 10 to 23%; and
a Ti content of 10 to 25%,
   in each instance relating to all metal atoms in the entire coating.

The coating preferably comprises two layers, wherein the lower layer is formed by a thicker (TiAlCrκ)N base coating in a composition as a homogeneous mixed phase that is covered by a thinner CrN covering coating as the upper layer. Preferably, yttrium is used as an element (κ) for grain refinement, wherein the percentage of the total metal content of the coating is below 1 at %, preferably up to approximately 0.5 at %.

Finally, according to another alternative, the hard material coating can essentially comprise nitrides with the metal components Cr, Ti and Al, and preferably with a small percentage of elements (κ) for grain refinement, with a structure as a double-layer coating, wherein the lower layer ( ) is formed by a thicker (TiAlCr)N base coating or (TiAlCrκ)N base coating in a composition as a homogeneous mixed phase that is covered by a thinner CrN covering coating as the upper layer, wherein the base coating comprises
a Cr content exceeding 30%, preferably 30 to 65%;
an Al content of 15 to 35%, preferably 17 to 25%; and
a Ti content of 16 to 40%, preferably 16 to 35%, particularly preferably 24 to 35%,
   in each instance relating to all metal atoms in the entire coating.

The overall thickness of the layer should be between 1 and 7 μm.

If a thicker base coating and a covering coating are used, the thickness of the lower coating should be between 1 and 6 μm and the thickness of the thinner covering coating should be between 0.15 to 0.6 μm.

Preferably the coating is deposited by means of cathodic arc vapour deposition or magnetron sputtering, and the surface of the tool, which surface carries the wear-resistant coating, is preferably subjected to substrate cleaning by means of plasma-supported etching using inert gas ions, preferably Ar ions.

The above description makes it clear that the method for trimming the lines of intersection makes do with simple axial movement of the tool 10, irrespective of the length of the axial extension EA (FIG. 1) of the line of intersection. It is sufficient to move the tool slowly from the position according to FIG. 5 to the position according to FIG. 6. The droplet-shaped design of the cutting head automatically ensures that the cutting edges 21 do not touch the internal surface of the borehole.

Of course, the method can also be designed such that during the trimming procedure the cutting head is moved several times to and fro between the positions shown in FIGS. 5 and 6, a procedure which can also take place so as to match the gradient of the line of intersection.

In relation to the geometry of the cutting head, too, the invention is not limited to the embodiments presented above. Examples for common and sensible embodiments of the cutting head are shown in FIGS. 9A to 9D, which embodiments as far as their shape and cutter design are concerned are guided by the designs of hard metal burrs, for example of the company August Rüggeberg GmbH & Co. KG, PFERD-Werkzeuge, 51709 Marienheide.

All the embodiments of FIGS. 9A to 9D share a common characteristic in that the respective cutting edge section 222, 322, 422 and 522 ends by a predetermined dimension MA in front of the region 229, 329, 429, 529 with the largest outer diameter.

In the variant according to FIG. 9A or 9C the cutting edge section comprises a tooth arrangement in the manner of a micro burr, while the embodiments according to FIGS. 9B and 9D comprise coarser cutting edges. The diagrams show that the axial length of the cutting edge section can be varied within wide limits, as can the axial length of the region 229 to 529. Similarly, the alignment of the cutting edges, namely helical according to FIG. 9B or axially according to FIG. 9D, can be selected as required, e.g. depending on the material to be cut. The tip of the cutting head can not only be of cylindrical shape, but also of flame shape, spherical shape, sphero-cylindrical shape, arch-pointed shape, conical pointed shape, arch-round shape or disc shape.

With reference to FIGS. 10 to 12 an exemplary embodiment of the invention is explained by means of which it becomes possible to effectively trim extremely small boreholes that are difficult to access. To simplify description, with this embodiment too, those components that correspond to the previously described variants have similar reference characters, which are, however, prefixed by “9”.

The borehole 912 to be trimmed is a borehole of, for example, 0.7 mm diameter and a length L of, for example, 6 to 7 mm, wherein this borehole continues on from a deep-hole borehole 970 which also has a small diameter DT of, for example, up to 4 mm and a depth TT of, for example, 80 mm. FIG. 11 shows the constellation in the region of the borehole 912 at a scale M of 10:1.

The dot-dash line shows the tip region of the trimming tool 910 whose cutting head 922 is inserted into the borehole 912 such that the outlet edge 916 can be trimmed.

FIG. 12 shows the tool 910 true to scale, namely at a scale M of approximately 5:1.

A shaft 920 follows on from a chuck section 944, with the length LS of said shaft 920 corresponding at least to the dimension TT of the borehole 970, and with the diameter DS of said shaft 920 being selected such that the shaft 920 can be accommodated with predetermined radial play SR in the borehole 970. FIG. 12 shows in dot-dash lines of the borehole 970 the position allocation between the borehole 970 and the tool 910 that has been inserted in the borehole for the purpose of carrying out the trimming process.

The shaft 920 again comprises an inner borehole 924 by way of which it is possible to feed pressure agent from the chuck section 944. Reference character 926 designates a radial duct whose outlet orifice faces the internal wall of the borehole 970 at a predefined spacing.

On the end facing away from the body 944, the shaft 920 carries a so-called trimming lance 974, which at the end of a pin 976 carries, the actual cutting head 922. The diameter D929 of the cutting head is slightly smaller than the diameter D912 of the borehole 912. As is also shown in FIG. 12 the trimming lance 974 is detachably attached to the tool shaft 920, for example screwed to said tool shaft 920 so that the inner borehole 924 is closed off.

The description of the tool shows that when the inner borehole 924 is subjected to pressure, radial deflection of the shaft 920 and thus of the cutting head 922 can be caused as a result of the circumferentially uneven distribution of the radial boreholes 926, by means of which deflection the trimming process can be carried out. The region 978 of the borehole 912 can be trimmed in the same manner as position 916. To this effect the cutting head can also comprise a cutting edge design on the other side of the region 929.

Designing the tool according to FIG. 12 makes it possible to use different materials for the sections 944, for the shaft 920 and for the actual trimming lance 974 with the cutting head 922. Since the shaft 920 in comparison to its diameter DS has a very long axial length, it has been shown to be advantageous to produce this shaft from a high-strength material whose elasticity has been selected such that the radial deflections that occur during trimming are situated exclusively in the elastic deformation region of the material. Suitable materials include hard materials, such as for example hard metals or cermets, as well as composite materials, such as for example carbon-fibre reinforced plastic composite materials.

Of course the shape of the cutting head 922 is not limited to the geometric shapes shown. Instead, any common geometric shape can be used, wherein the design of the cutters can also be varied within a wide range. The length L976 of the pin 976 is selected depending on the axial length of the borehole 912.

In relation to the design of the radial borehole 926 there is also wide scope for its design or variation according to size, position and number, as has also been described in the exemplary embodiments described above.

The tool according to FIG. 12 can of course also be stimulated to carry out the movements required for the trimming process by means of an unbalanced mass integrated in the tool.

Of course, deviations from the embodiments described are possible without leaving the fundamental idea on which the invention is based.

For example, several internal flow-agent ducts can be provided.

If the tool is used for trimming several boreholes that are staggered in axial direction, it is advantageous to carry out flow-agent supply to the tool with increased pressure only when the cutting head reaches the vicinity of the borehole outlet to be trimmed.

The invention thus provides a tool for trimming lines of intersection on the ends of boreholes, such as boreholes that end laterally in a cylindrical recess, for example. Said tool has a cutting head which is arranged on a shaft that has at least one cutting edge that extends in the axial direction, at least in sections, and carries out a machining process by a relative rotational movement between the tool and the workpiece. The tool according to the invention is provided with a device for generating a radial force, by which means the cutting head can be radially deflected in the rotational movement thereof in a preferably controlled manner, said cutting head having a diameter that is selected such that it can be introduced into the borehole with radial play. The cutting head is essentially in the form of a droplet and has a smooth closed surface in the region of the largest outer diameter thereof.

1. A tool for trimming lines of intersection on the ends of boreholes, such as boreholes that end laterally in a cylindrical recess, for example; said tool having a cutting head (22; 222; 322; 422; 522; 922) which is arranged on a shaft (20; 120; 220; 520) and at least one cutting edge (21; 221; 321; 421, 521; 921) that extends in the axial direction, at least in sections, and carries out a machining process by a relative rotational movement between the tool and the workpiece, wherein the tool is provided with a device for generating a radial force, by which means the cutting head can be radially deflected in the rotational movement thereof in a preferably controlled manner, said cutting head having a diameter (DS) that is selected such that it can be introduced into the borehole (12; 912) with radial play (SR), wherein the cutting head is essentially in the form of a droplet, characterised in that the cutting head (22; 222; 322; 422; 522; 922) has a smooth closed surface in the region (29; 229; 329; 429; 529; 929) of the largest outer diameter thereof.

2. The tool of claim 1, characterised in that the device for generating a radial force, which device is integrated in the tool, comprises at least one interior flow-agent duct (24; 124; 924) from which at least one branch duct (26; 926) emanates which ends in an outer circumferential surface of the tool.

3. The tool according to claim 1, characterised in that the branch duct (26; 926), of which there is at least one, has a diameter ranging from 0.1 mm to 5 mm.

4. The tool according to claim 1, characterised in that the branch duct (26), of which there is at least one, is formed by a borehole.

5. The tool according to claim 4, characterised in that the branch duct (26), of which there is at least one, is formed by an eroded recess.

6. The tool according to claim 2, characterised in that the shaft (20) at the end facing away from the cutting head comprises a body (44; 144), by way of which the flow agent can be fed to the flow-agent duct (24), of which there is at least one.

7. The tool according to claim 6, characterised in that the body for feeding-in the flow agent at the same time forms an attachment- and fastening body (44; 144) by means of which the tool can be fastened in a tool-holding fixture (130) so as to be torsionally rigid and non-slidable.

8. The tool according to claim 1, characterised in that the device for generating a radial force, which device is integrated in the tool, is formed by an unbalanced mass.

9. The tool according to claim 8, characterised in that the unbalanced mass is formed in one piece with the tool.

10. The tool according to claim 8, characterised in that the unbalanced mass is attached to the tool as a separate component, preferably so that the position of said unbalanced mass can be changed.

11. The tool according to claim 1, characterised by a plural number of cutting edges (21; 221; 321; 421, 521; 921) that are distributed around the circumference.

12. The tool according to claim 1, characterised in that the length of the shaft (20) ranges from 5 to 1,000 mm.

13. The tool according to claim 1, characterised in that the shaft (20; 920) tapers off in relation to the diameter (DS) of the cutting head (22; 922).

14. The tool according to claim 1, characterised in that the cutting edge, of which there is at least one, is set at an angle in relation to an axial plane of the tool (10).

15. The tool according to claim 1, characterised in that the cutting head (22) comprises a cylindrical or spherical tip section, and the smooth cutting edge (21), of which there is at least one, is formed at the end of the smooth closed surface (29) that faces the shaft of the tool.

16. The tool according to claim 15, characterised in that the tip section on its end facing away from the shaft comprises a start of a cut that is formed by a chamfer or a round shape.

17. The tool according to claim 2, characterised in that the radial play (SR) of the cutting head (22) and/or of the external surface (20) of the tool in the region of the outlet point (28) of the radial branch duct (26) ranges between 0.1 and 5 mm.

18. The tool according to claim 1, characterised in that at least the cutting head is made from high-strength material such as for example from wear-resistant steel, high-speed steel such as HSS, HSSE or HSSEBM, hard metal, ceramics, cermet or some other sintered metal material.

19. The tool according to claim 1, characterised in that on its end facing away from the cutting head (22) the shaft (20) comprises an attachment- and fastening body (44; 144) by means of which the tool can be fastened to a tool-holding fixture (130) so as to be torsionally rigid and non-slidable.

20. The tool according to claim 1, characterised in that the cutting edge (21), of which there is at least one, has a positive effective cutting angle (RSW).

21. The tool according to claim 1, characterised in that the cutting edge, of which there is at least one, has a negative effective cutting angle.

22. The tool according to claim 1, characterised in that the cutting edge (21), of which there is at least one, extends so as to be essentially of helical shape.

23. The tool according to claim 1, characterised in that at least the shaft (20; 920) is made from high-strength material such as for example from a hard material, hard metal, a cermet material or a composite material such as for example a carbon-fibre reinforced plastic material and has such elasticity that radial deflections of the cutting head and thus of the shaft, which radial deflections occur during the trimming process, occur exclusively in the elastic deformation region.

24. The tool according to claim 1, characterised by a coating, at least in some regions, preferably in the embodiment of a hard material coating.

25. The tool according to claim 24, characterised in that the hard material coating comprises diamond, preferably nanocrystalline diamond, made of TiN or (Ti, Al)N, a multilayer coating or a coating comprising nitrides with the metal components Cr, Ti and Al and preferably a small percentage of elements for grain refinement, wherein the Cr content is 30 to 65%, preferably 30 to 60%, particularly preferably 40 to 60%, the Al content is 15 to 35%, preferably 17 to 25%, and the Ti content is 16 to 40%, preferably 16 to 35%, particularly preferably 24 to 35%, in each case in relation to all metal atoms in the entire coating.

26. The tool according to claim 25, characterised in that the structure of the entire coating comprises a homogeneous mixed phase.

27. The tool according to claim 25, characterised in that the structure of the entire coating has several individual layers that are homogeneous per se, which alternately comprise on the one hand (TiₓAl_{y}Y_{z})N, wherein x=0.38 to 0.5, and y=0.48 to 0.6, and z=0 to 0.04, and on the other hand CrN, wherein preferably the uppermost layer of the wear-resistant coating is formed by the CrN coating.

28. The tool according to claim 24, characterised in that the hard material coating essentially comprises nitrides with the metal components Cr, Ti and Al and a small percentage of elements (κ) for grain refinement, with the following composition:
a Cr content exceeding 65%, preferably ranging from 66 to 70%;
an Al content of 10 to 23%; and
a Ti content of 10 to 25%,
in each instance relating to all metal atoms in the entire coating.

29. The tool according to claim 28, characterised in that the coating comprises two layers, wherein the lower layer is formed by a thicker (TiAlCrκ)N base coating in a composition as a homogeneous mixed phase that is covered by a thinner CrN covering coating as the upper layer.

30. The tool according to claim 28, characterised in that yttrium is used as an element (κ) for grain refinement, wherein the percentage of the total metal content of the coating is below 1 at %, preferably up to approximately 0.5 at %.

31. The tool according to claim 24, characterised in that the hard material coating essentially comprises nitrides with the metal components Cr, Ti and Al, and preferably with a small percentage of elements (κ) for grain refinement, with a structure as a double-layer coating, wherein the lower layer ( ) is formed by a thicker (TiAlCr)N base coating or (TiAlCrκ)N base coating in a composition as a homogeneous mixed phase that is covered by a thinner CrN covering coating as the upper layer, wherein the base coating comprises
a Cr content exceeding 30%, preferably 30 to 65%;
an Al content of 15 to 35%, preferably 17 to 25%; and
a Ti content of 16 to 40%, preferably 16 to 35%, particularly preferably 24 to 35%,
in each instance relating to all metal atoms in the entire coating.

32. The tool according to claim 24, characterised in that the overall thickness of the layer is between 1 and 7 μm.

33. The tool according to claim 27, characterised in that the thickness of the lower coating is between 1 and 6 μm and the thickness of the thinner covering coating is between 0.15 to 0.6 μm.

34. The tool according to claim 24, characterised in that the coating is deposited by means of cathodic arc vapour deposition or magnetron sputtering.

35. The tool according to claim 24, characterised in that the surface of the tool, which surface carries the wear-resistant coating, is subjected to substrate cleaning by means of plasma-supported etching using inert gas ions, preferably Ar ions.

36. The tool according to claim 35, characterised in that plasma-supported etching is carried out by means of low-voltage arc discharge.

37. A method for trimming boreholes that end laterally in a cylindrical recess (14), for example, by means of a tool according to claim 1, wherein the pressure of the flow agent that is fed through the tool (10) that has been inserted into the borehole (12) is used to radially deflect the cutting head (22) and in this way to let the cutting edge (21), of which there is at least one, engage the burr to be removed, characterised in that the pressure is built up after the cutting head (22) has been moved into the borehole sufficiently far for its cutting edge (21), of which there is at least one, to overlap the outlet orifice (16) of the borehole at least in some regions.

38. The method according to claim 37, characterised by the following sequential process steps:
a) building up a relative rotary movement between the tool and the workpiece while the tool is located outside the borehole;
b) axially moving the tool (10) in relation to the borehole (12);
c) building up a flow of the pressurised flow agent through the tool (10) with concurrent radial deflection of the cutting head (22) as soon as the cutting edge (21), of which there is at least one, overlaps the outlet orifice (16) of the borehole at least in some regions; and
d) carrying out an axial relative movement (V) between the tool (10) and the borehole (12) in order to subject the entire outlet orifice (16) to the trimming process.

39. The method according to claim 38, characterised in that the tool (10) and/or the workpiece are/is driven at a rotational speed ranging from 100 to 50,000 rpm.

40. The method according to claim 37, characterised in that a cutting speed ranging from 20 to 300 m/min is selected.
